(19) United States
(12) Patent Application Publication
(10) Pub. No.: US 2015/0007571 A1
(43) Pub. Date: Jan. 8, 2015

(54) GAS TURBINE COMBUSTOR

(71) Applicant: ALSTOM Technology Ltd, Baden (CH)

(72) Inventors: Ennio PASQUALOTTO, Winterthur (CH); Jaan HELLAT, Zumikon (CH); Pirmin SCHIESSEL, Ehrendingen (CH)

(21) Appl. No.: 14/494,984

(22) Filed: Sep. 24, 2014

Related U.S. Application Data
(63) Continuation of application No. PCT/EP2013/056188, filed on Mar. 25, 2013.

(30) Foreign Application Priority Data
Mar. 29, 2012 (EP) 12162112.2

(51) Int. Cl. F23R 3/28; F02C 7/24; F23R 3/34

(52) U.S. Cl. CPC F23R 3/286; F23R 3/34; F02C 7/24
USPC 60/725; 60/737; 60/746

(57) ABSTRACT

A combustor for a gas turbine that includes a front panel, an elongated sleeve with first end and second ends and a burner mounted in the sleeve. The second end of the sleeve seallessly mounted on the front panel. The sleeve and burner are configured to enable slidable mounted of the burner in the sleeve.

### CROSS-REFERENCE TO RELATED APPLICATIONS

This application claims priority to PCT/EP2013/056188 filed Mar. 25, 2013, which claims priority to European application 12162112.2 filed Mar. 29, 2012, both of which are hereby incorporated in their entireties.

### TECHNICAL FIELD

The present disclosure relates generally to combustors for use in gas turbines and more specifically to pre mix burner configurations and arrangements suitable for these combustors.

### BACKGROUND

An industrial gas turbine typically includes a compressor and a turbine conventionally arranged on a common shaft. Between the compressor and turbine is a combustion chamber, in which typically a plurality of burners are located. The burners generate hot combustion gases from the combustion of gaseous and/or liquid fuel. A type of burner that may be utilized in a combustor includes a lance type extractable burner. The extraction of such burners typically requires an opening in the outer cases of comparable size to the diameter of the burner. The larger the diameter of the burner, the large the comparable opening in the outer casing and the higher the manufacturing cost.

The combustion air necessary for the combustion of the fuel is sucked in by the compressor via an air feed, compressed and subsequently fed, via a compressed-air duct, into a plenum chamber, from where it passes through corresponding orifices into the burner. The hot combustion gases from the combustion chamber pass, via a hot-gas duct, into the turbine where work is performed in one or more stages. Due to the temperature of the combustion gases and the need to ensure that combustion gas do not leak out, all sealed joins within the combustor need to be purged, typically with purge air. However, the addition of purge air has a negative impact on gas turbine efficiency. It is therefore desirable to provide designs that minimise the need for seals.

A problem that may occur in the combustor of such industrial gas turbines is pressure oscillations. Pressure oscillations can reduce part life and may result in the de-rating of the turbine power output. US application number US2004/001020 A1 discloses a control unit that controls at least one of a fuel flow rate and an airflow rate of air to overcome oscillations. There is, however, a need to provide alternative methods of overcoming oscillations that do not affect the turbine capacity or performance.

### SUMMARY

The disclosure is intended to provide a combustor burner that facilities a more cost effective extraction of burners and enables tuning to overcome pressure oscillations.

It attempts to address these problems by means of the subject matter of the independent claim. Advantageous embodiments are given in the dependent claims.

The disclosure is based on the general idea of providing a burner that is moveably mounted within a sleeve that is either fixed to or otherwise forms part of the front panel of the combustor liner.

One aspect of the disclosure is to provide a combustor in which the burner is movable in an axial direction inside a sleeve and relative to the sleeve during operation of the combustor.

An aspect provides a combustor for a gas turbine comprising a front panel to which a second end of an elongated sleeve is seallessly mounted. The combustor further comprises a burner mounted in the sleeve. The sealless mounting reduces the need for post combustion air purging within the combustor, which would otherwise be required to prevent combustion gas leakage through the seal and maintain seal temperature. The burner can be a mixing region of the combustor where fuel is introduced and mixed with the combustion gases. Downstream of the front panel the combustor can have a combustion region. The front panel is generally orientated perpendicular to the main flow direction. At the front panel the flow area increases. Typically this increase in flow area is in a stepwise manner.

In another aspect, the burner is configured to be a slidably extractable burner and the mounting in the sleeve enables axial insertion and mounting within the sleeve. As the sleeve is not part of the burner, the burner diameter is minimised. This makes it possible to simplify the design of the outer casing.

In another aspect, the burner comprises a body and a conically expanding swirl shell extending from the body at a first narrow end to a second wider distal end. In this aspect, the sleeve shrouds the swirl shell so as to ensure an even velocity distribution along the shell. This results in a lower pressure drop across the burner. The efficiency of the air distribution is further enhanced by the sleeve, at the first upstream end, having a conical mouth for directing combustion gases in the axial direction.

In another aspect, the outlet of the sleeve, at the second downstream end, has a bell shaped outlet for providing flame stability.

In another aspect, the burner comprises a burner ring having a first upstream end, a second distal downstream end, an inner surface and an outer surface wherein the burner ring is fixingly mounted to the distal second end of the swirl shell on the inner surface of the burner ring at a point between the first and second burner ring ends so as to a least partially shroud the swirl shell. The burner ring improves the stability of the mounting of the burner within the sleeve by increasing the axial contact surface between the sleeve and the burner.

In another aspect, a seal for sealing a cavity formed between the burner ring and the sleeve is located on either the burner ring or the sleeve, wherein the seal defines a mounting point between the burner ring and the sleeve. The seal minimises the potential for gas leakage behind the burner.

In an aspect, the seal is a labyrinth and piston ring seal and the seal is located on the outer surface of the burner ring.

In an aspect, the sleeve comprises a plurality of purge holes through the sleeve therethrough that circumscribe the sleeve. The purge holes enable the purging of the cavity between the burner ring and the sleeve. Preferably, the purge holes are located such that when the burner ring is mounted in the sleeve, the purge holes are capable of directing purge gas to an annular gap, formed between the outer surface of the burner ring and the sleeve, and extending from downstream end of the seal.

In an aspect, the seal is located on the outer surface of the burner ring towards the first upstream end of the burner ring. The location of the seal towards the upstream end of the burner ring makes it possible to extend the axial variation of the mounting of the burner within the sleeve while maintaining the purge holes at the downstream end of the seal.

In an aspect, the combustor comprises a plurality of circumferentially fixed sleeves and burners of other aspects of the disclosure, wherein the axial alignment of at least two of the burners is staggered. This is enabled by the slidable characteristic of the burner within the sleeve. In a system with a plurality of burners, the ability to axially stagger the relative location of the burners provides an effective means to tune out pressure oscillations without there being a further need to adjust fuel or air flows or other operating conditions.

It is a further object of the invention to overcome or at least ameliorate the disadvantages and shortcomings of the prior art or else provide a useful alternative.

Other aspects and advantages of the present disclosure will become apparent from the following description, taken in connection with the accompanying drawings, by way of illustrated exemplary embodiments of the present disclosure.

### BRIEF DESCRIPTION OF THE DRAWINGS

By way of example, embodiments of the present disclosure are described more fully hereinafter with reference to the accompanying drawings, in which:

FIG. 1 is a cut through view of an exemplary combustor according to a preferred embodiment of the disclosure wherein FIG. 1a shows a burner mounted in a sleeve while FIG. 1b shows a burner extracted from the sleeve;

FIG. 2 is a cut through view of an exemplary embodiment of a burner and sleeve suitable for the combustor of FIG. 1;

FIG. 3 is an expanded cut view of a section of the burner ring and sleeve of FIG. 2;

FIG. 4 is a cut through view of an exemplary embodiment of a burner and sleeve suitable for the combustor of FIG. 1;

FIG. 5 is a schematic diagram of the burner of FIG. 1 with a partially cut away sleeve; and

FIG. 6 is a cut through view of an exemplary embodiment with multiple exemplary burners as shown in FIG. 2, in which the burners have staggered axial alignment.

### DETAILED DESCRIPTION

Exemplary embodiments of the present disclosure are now described with references to the drawings, wherein like reference numerals are used to refer to like elements throughout. In the following description, for purposes of explanation, numerous specific details are set forth to provide a thorough understanding of the disclosure. However, the present disclosure may be practiced without these specific details, and is not limited to the exemplary embodiments disclosed herein.

Throughout this specification reference is made to the axial direction. Axial direction refers to the axis of the burner 30. In addition, upstream and downstream is made in reference to the normal fuel/air flow direction when the burner 30 is in service.

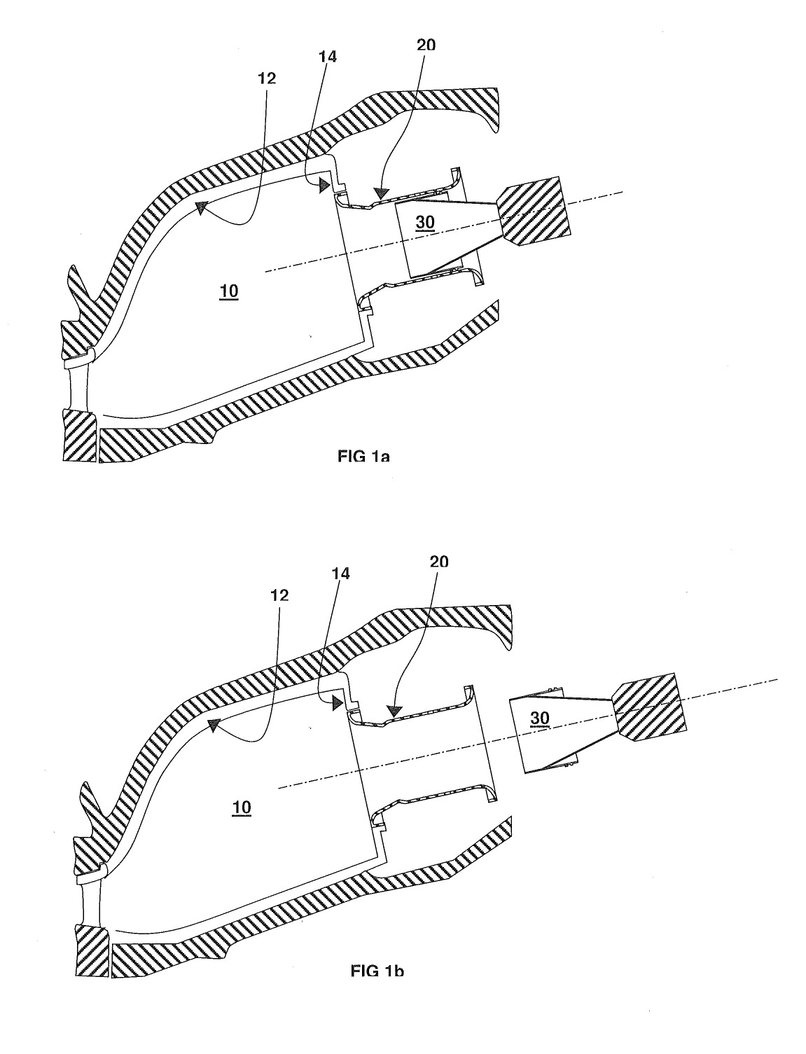

In an exemplary embodiment shown in FIG. 1, a combustor 10 for a gas turbine comprises a liner 12 that includes a front panel 14. The purpose of the liner 12 is to withstand combustor temperatures, contain combustion gases in the combustor 10 and direct them to a first stage of a turbine. The purpose of the front panel 14 is to provide a transition from the orthogonally aligned end face of the burner 30 to the axial extension of the combustor 10 as well as to provide a mounting point for the burner 30. Fixingly mounted to the front panel 14 of the combustor 10 is, at its second downstream end 24, an elongated sleeve 20. The mounting is configured such that there is no movement between the front panel 14 and the sleeve 20. This involves the join being gapless and therefore without a requirement for a seal. The mounting is not, however, limited to the joining of two separate pieces but may also include a single element in which a front panel 14 portion is integrally formed with the sleeve 20 portion.

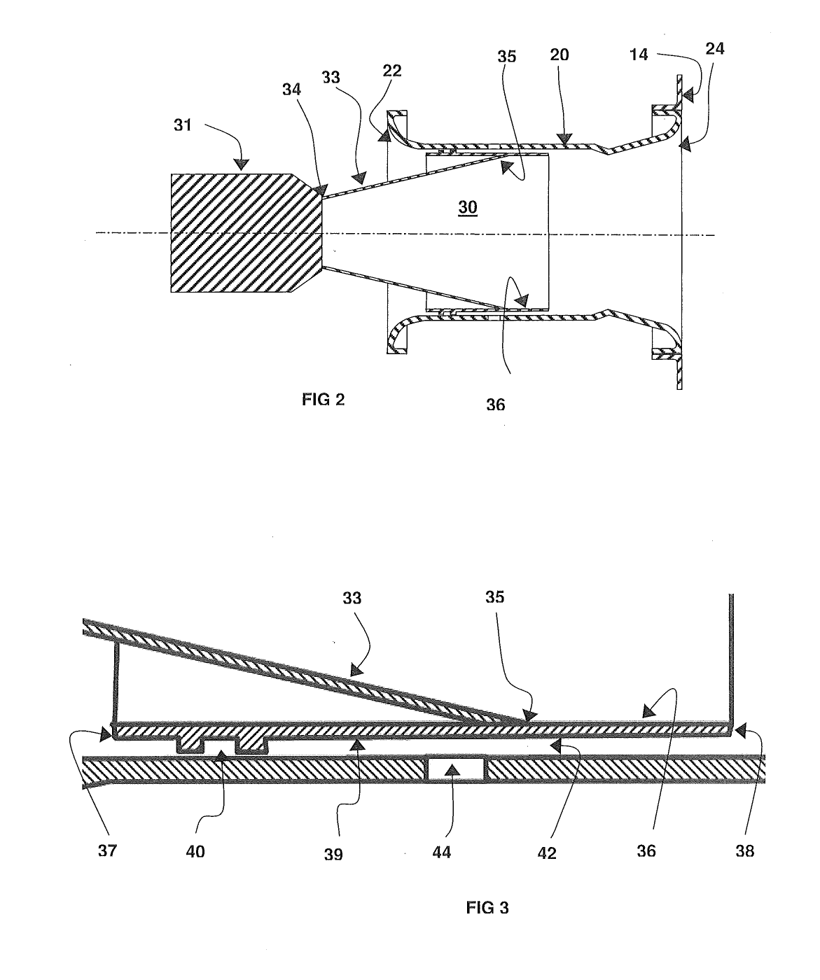

In an exemplary embodiment shown in FIG. 2, the mounting of the burner 30 and the shape of the burner 30 relative to the sleeve 20 is such that the burner 30 may be slidably extracted from within the sleeve 20, as shown in FIG. 1b. When the burner 30 is an extractable type burner 30, the reduce diameter of the burner 30 simplifies extraction and outer casing design,

The burner 30 of an exemplary embodiment, as shown in FIG. 2, is a swirl flow burner 30 comprising an upstream section that includes a swirl shell 33 where fuel is injected and brought in contact with combustion air. The swirl shell 33 comprises a conically expanding section that extends from a burner body 31. Fuel may be injected along the axial length of the swirl shell 33 configured to promote swirl flow.

As shown in FIG. 2, in an exemplary embodiment, the burner 30 is mounted within the sleeve 20 such that the sleeve 20 encompasses or shrouds at least a portion of the burner 30. The mounted of the burner 30 within the sleeve 20 and the axial extension of the sleeve 20 is such that the sleeve 20, as shown in FIG. 2, encompasses and/or shrouds the swirl shell 33 of the burner 30 and further extends beyond the swirl shell 33 in the downstream axial direction. The sleeve 20, although not an integral part of the burner 30 in that it is not fixingly mounted to the burner 30, performs the function of a mixing section downstream of the swirl shell 33 to ensure uniform mixing of fuel and air.

In an exemplary embodiment as shown in FIG. 2, the sleeve 20, at the first upstream end, has a conical mouth for directing combustion gases in the axial direction.

The burner 30 is slidably mounted in the sleeve 20 so as to enable axial adjustment of the burner 30. This slidable mounting further enables the burner 30 to be extracted from the combustor 10 independent of the sleeve 20. This is achieved by the relative shape of the sleeve 20 and the second end of the swirl shell 33, as shown in FIG. 1b. In an exemplary embodiment, the sleeve 20 is shaped to have an axially extending region of constant or near constant diameter.

In an exemplary embodiment shown in FIG. 2 the second end of the sleeve 20, that is the outlet of the sleeve 20, has a bell shaped outlet in order to assist in flame stabilisation.

In an exemplary embodiment shown in FIG. 2, attached to the axially distal end of the burner swirl shell 33 is a burner ring 36. The burner ring 36 facilitates the slidable mounting of the burner 30 within the sleeve 20 by being shaped to complement the inner shape of sleeve 20 in the region sleeve 20 between its distal ends that have constant or near constant diameter.

In an exemplary embodiment shown in FIG. 3, a seal 40 is located in a cavity 42 between the burner ring 36 and the sleeve 20. The seal 40, which maybe located on either the burner ring 36 or the sleeve 20, is a contact point between the burner ring 36 and the sleeve 20 so by defining a mounting point between for the burner ring 36 on the sleeve 20. In an exemplary embodiment, the seal 40 is located on the outer surface 39 of the burner ring 36. In a further exemplary embodiment shown in FIG. 2, the mounting point is the only point of contact between the burner ring 36 and the sleeve 20.

In an exemplary embodiment shown in FIG. 3, the mounting of the burner ring 36 is such that the burner ring's first end 37 is located towards the upstream end of the burner 30 and the burner ring second end 38 is located towards the distal downstream end of the burner 30. In this arrangement, the seal 40 is located on the outer surface 39 of the burner ring 36 towards the burner ring first end 37.

In an exemplary embodiment shown in FIG. 3, the seal 40 is a labyrinth and piston ring seal, however other sealing arrangements capable of maintaining a seal between two essentially flat surfaces under the temperature and pressure conditions of the combustor 10 may be used.

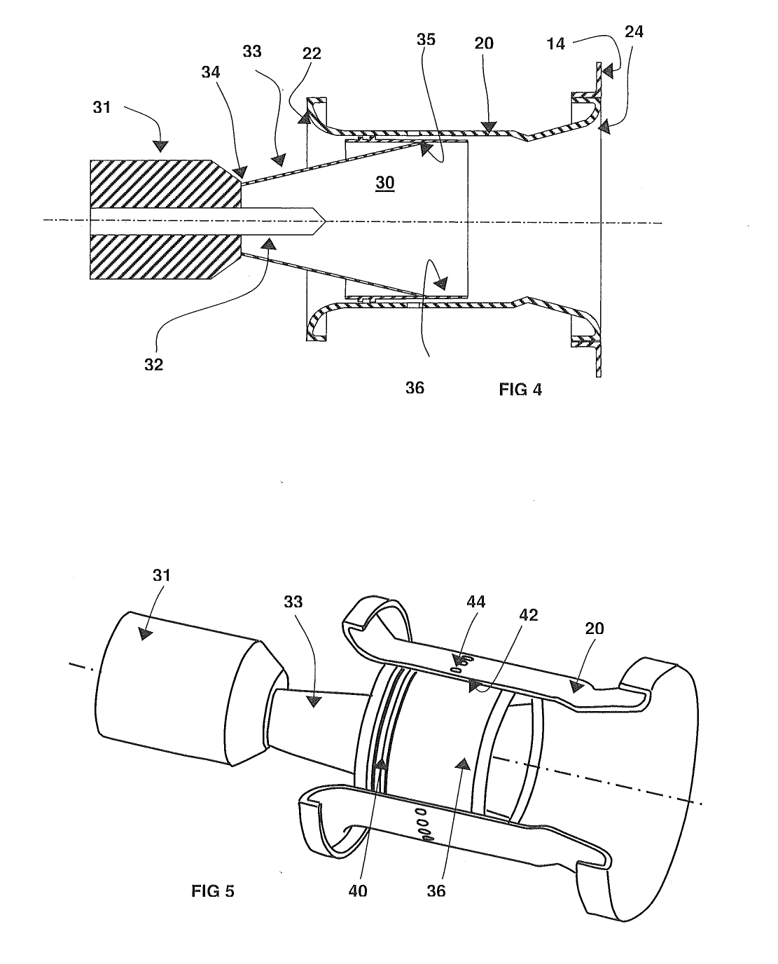

In a further exemplary embodiment shown in FIG. 4, the burner body 31 further comprises a lance 32 extending through the burner body 31 and further out into a cavity formed by the burner swirl shell 33. In an exemplary embodiment, the purpose of the lance 32 is to provide an additional fuel addition means for oil premix gas and pilot injection.

In an exemplary embodiment shown in FIG. 5, the sleeve 20 comprises a plurality of purge hole through the sleeve 20 therethrough that circumscribe the sleeve 20. The purge holes 44 are located downstream of a seal 40 between the burner ring 36 and the sleeve 20. A purpose of the purge holes is to provide a means of purging the cavity 42 formed between the burner ring 36 and the sleeve 20 of fuel/air mixtures and thus help prevent possible leakage of the mixture back through the seal 40.

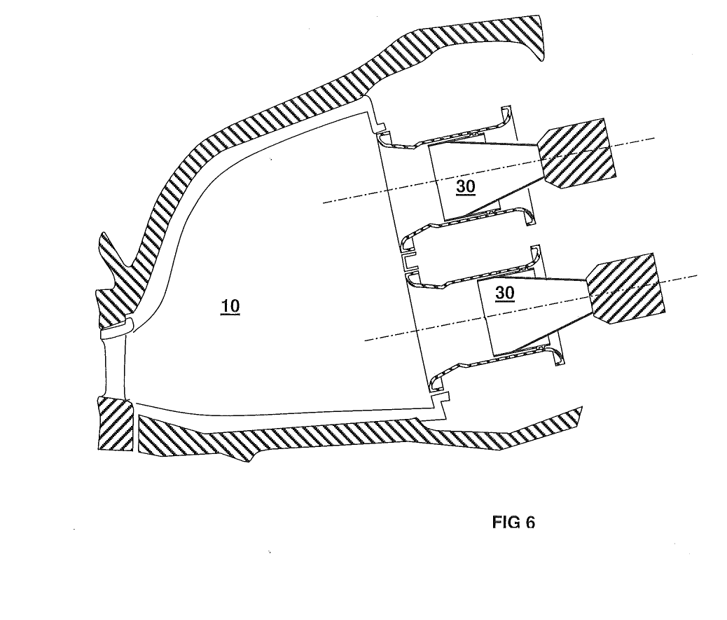

In an exemplary embodiment shown in FIG. 6, the combustor 10 comprises a plurality of fixed sleeves 20 and burners 30, wherein the axial alignment of at least two of the burners 30 is staggered.

Although the disclosure has been herein shown and described in what is conceived to be the most practical exemplary embodiments, the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather that the foregoing description and all changes that come within the meaning and range and equivalences thereof are intended to be embraced therein.

1. A combustor for a gas turbine comprising:
a front panel;
an elongated sleeve with a first end and a second end; and
a burner mounted in the sleeve, wherein the second end of the sleeve seallessly mounted on the front panel.

2. The combustor of claim 1 wherein the burner is movable in an axial direction inside a sleeve and relative to the sleeve during operation of the combustor.

3. The combustor of claim 1 wherein the burner is slidably mounted in the sleeve so as to enable axial adjustment of the burner within the sleeve.

4. The combustor of claim 1 wherein the sleeve, at the second end, has a bell shaped.

5. The combustor of claim 1, wherein the burner comprises:
a burner body; and
a conically expanding swirl shell, extending from the body, having a narrow first end and a wider distal second end, wherein the sleeve shrouds the swirl shell.

6. The combustor of claim 1 wherein the burner comprises:
a burner ring having:
a first end towards an axial upstream end of the burner;
a second distal end towards an axial downstream end of the burner; and
an outer surface,
wherein the burner ring is fixingly mounted to the swirl shell second end on an inner surface of the burner ring at a point between the burner ring first end and the burner ring second end so as to a least partially shroud the swirl shell.

7. The combustor of claim 6 further comprising a seal for sealing a cavity formed between the burner ring and the sleeve wherein the seal is located on either the burner ring or the sleeve.

8. The combustor of claim 7 wherein the seal is a labyrinth and piston ring seal.

9. The combustor of claim 7 wherein the seal is located on the outer surface of the burner ring.

10. The combustor of claim 7 wherein the seal is located towards the first end of the burner ring.

11. The combustor of claim 8 wherein the seal is located on the outer surface of the burner ring towards the burner ring first end.

12. The combustor of claim 7 wherein the sleeve comprises a plurality of purge holes therethrough configured and located such that the purge holes are capable of directing purge gas into an annular gap formed between the burner ring outer surface and the sleeve between the seal and the burner ring second end.

13. The combustor of claim 12 wherein the plurality of purge holes circumscribe the sleeve.

14. The combustor of claim 5 wherein the burner body further comprises a lance, axially extending through the burner body and out from the burner body into a cavity formed in the swirl shell, for oil premix and gas pilot injection.

15. The combustor of claim 1 wherein the combustor further comprises a plurality of sleeves and burners, wherein at least two of the burners in the sleeves are axially staggered.
